(19) United States
(12) Patent Application Publication
(10) Pub. No.: US 2026/0219540 A1
(43) Pub. Date: Jul. 30, 2026

(54) LIQUID CRYSTAL DEVICE AND ELECTRONIC INSTRUMENT

(71) Applicant: SEIKO EPSON CORPORATION, Tokyo (JP)

(72) Inventor: Yukihiro SUGIURA, CHITOSE-SHI (JP)

(73) Assignee: SEIKO EPSON CORPORATION, Tokyo (JP)

(21) Appl. No.: 19/461,737

(22) Filed: Jan. 28, 2026

(30) Foreign Application Priority Data
Jan. 30, 2025 (JP) 2025-013705

(51) Int. Cl. G02F 1/137; G02F 1/1337; G02F 1/1343; G02F 1/1362

(52) U.S. Cl. CPC G02F 1/13712; G02F 1/1337; G02F 1/134336; G02F 1/136286

(57) ABSTRACT

A liquid crystal device includes a first substrate, a second substrate, and a liquid crystal layer interposed between the first substrate and the second substrate and including liquid crystal molecules having negative dielectric anisotropy. The first substrate includes multiple scan lines, multiple data lines, multiple pixel electrodes, multiple liquid crystal alignment control electrodes that control azimuth angle directions of major axes of the liquid crystal molecules when a voltage is applied to the liquid crystal layer, and an alignment film that imparts a pretilt angle to the liquid crystal molecules. The liquid crystal alignment control electrodes generate an electric field acting in a direction opposite a direction in which the liquid crystal molecules are rotated to be oriented in an azimuth angle direction when voltages different from each other are applied to two of the pixel electrodes that are adjacent to each other.

The present application is based on, and claims priority from JP Application Serial Number 2025-013705, filed January 30, 2025, the disclosure of which is hereby incorporated by reference herein in its entirety.

### BACKGROUND

### 1. Technical Field

The present disclosure relates to a liquid crystal device and an electronic apparatus.

### 2. Related Art

A vertical-alignment-mode liquid crystal device, in which liquid crystal molecules are vertically aligned with respect to substrates when no voltage is applied to the liquid crystal molecules, has been known as related art. In a vertical-alignment-mode liquid crystal device, the liquid crystal molecules have negative dielectric anisotropy, and when an electric field in the direction perpendicular to the substrates is applied to the liquid crystal molecules, the major axes of the liquid crystal molecules tilt and become parallel to the substrates. A vertical-alignment-mode liquid crystal device, when combined with a polarizer disposed in the crossed-Nicols arrangement, is characterized by an excellent black level and high contrast with no voltage applied to the liquid crystal molecules. However, when voltages different from each other are applied to two pixel electrodes adjacent to each other, a lateral electric field is generated between the pixels adjacent to each other in addition to a longitudinal electric field generated between the two substrates. When the lateral electric field acts on the liquid crystal molecules, a region in which the liquid crystal molecules tilt in a direction different from a direction in which the liquid crystal molecules should tilt, that is, what is called a reverse tilt domain is generated, resulting in a problem of display failure.

JP-A-2021-086011 discloses a liquid crystal device including a vertical-alignment-mode liquid crystal layer, pixel electrodes, and protrusions provided on the lower side of the pixel electrodes and extending along end portions of the pixel electrodes. JP-A-2021-086011 describes that since the end portion of each of the pixel electrodes is located above the protrusion, the strength of the longitudinal electric field between the pixel electrode and the common electrode increases, whereas the strength of the lateral electric field between adjacent pixel electrodes decreases, so that the display failure due to the reverse tilt domain can be solved.

JP-A-2021-086011 is an example of the related art.

In the liquid crystal device disclosed in JP-A-2021-086011, however, there is a concern that the alignment of the liquid crystal molecules is disturbed around the protrusions protruding toward the liquid crystal layer, and that the display failure cannot be sufficiently solved due to the disturbance of the alignment. It is therefore desired to provide a liquid crystal device capable of solving the display failure due to the reverse tilt domain by using a solution different from that used in JP-A-2021-086011.

### SUMMARY

A liquid crystal device according to an aspect of the present disclosure includes a first substrate, a second substrate, and a liquid crystal layer interposed between the first substrate and the second substrate and including liquid crystal molecules having negative dielectric anisotropy. The first substrate includes multiple scan lines, multiple data lines extending in a direction that intersects with a direction in which the scan lines extend, multiple pixel electrodes arranged in a matrix in correspondence with intersections of the scan lines and the data lines, multiple liquid crystal alignment control electrodes configured to control azimuth angle directions of major axes of the liquid crystal molecules when a voltage is applied to the liquid crystal layer, and an alignment film provided on a side of the first substrate that is a side in contact with the liquid crystal layer, and configured to impart a pretilt angle to the liquid crystal molecules. The liquid crystal alignment control electrodes are configured to generate an electric field that generates a second torque acting in a direction opposite a direction in which a first torque acts, the first torque generated when voltages different from each other are applied to two of the pixel electrodes that are adjacent to each other, the first torque rotating the liquid crystal molecules to be oriented in an azimuth angle direction.

An electronic instrument according to another aspect of the present disclosure includes the liquid crystal device according to the aspect of the present disclosure.

### BRIEF DESCRIPTION OF THE DRAWINGS

FIG. 1 is a plan view of a liquid crystal device according to a first embodiment.

FIG. 2 is a cross-sectional view of the liquid crystal device taken along the line II-II in FIG. 1.

FIG. 3 is an equivalent circuit diagram showing the electrical configuration of an element substrate.

FIG. 4 is a cross-sectional view showing a schematic configuration of the element substrate.

FIG. 5 is a plan view showing a pattern shape of each layer that constitutes the element substrate.

FIG. 6 is a diagrammatic view showing an electrical coupling relationship between pixel electrodes and liquid crystal alignment control electrodes.

FIG. 7 is a cross-sectional view of the element substrate taken along the line VII-VII in FIG. 5.

FIG. 8 is a cross-sectional view of the element substrate taken along the line VIII-VIII in FIG. 5.

FIG. 9 is a diagrammatic view showing a mechanism that generates a reverse tilt domain.

FIG. 10 is a diagrammatic view showing an example of a mechanism that solves the reverse tilt domain.

FIG. 11 shows a result of a simulation of the reverse tilt domain in related art.

FIG. 12 shows a result of the simulation of the reverse tilt domain.

FIG. 13 is a diagrammatic view showing another example of the mechanism that solves the reverse tilt domain.

FIG. 14A shows the effect of solving the reverse tilt domain in a case where a specific pattern is displayed.

FIG. 14B shows the effect of solving the reverse tilt domain in a case where another pattern is displayed.

FIG. 14C shows the effect of solving the reverse tilt domain in a case where another pattern is displayed.

FIG. 14D shows the effect of solving the reverse tilt domain in a case where another pattern is displayed.

FIG. 15 shows a coupling relationship between the pixel electrodes and the liquid crystal alignment control electrodes in a second embodiment.

FIG. 16A shows the effect of solving the reverse tilt domain in a case where a specific pattern is displayed.

FIG. 16B shows the effect of solving the reverse tilt domain in a case where another pattern is displayed.

FIG. 16C shows the effect of solving the reverse tilt domain in a case where another pattern is displayed.

FIG. 16D shows the effect of solving the reverse tilt domain in a case where another pattern is displayed.

FIG. 17 shows the coupling relationship between the pixel electrodes and the liquid crystal alignment control electrodes in a third embodiment.

FIG. 18 is a cross-sectional view of the element substrate.

FIG. 19 is a cross-sectional view of the element substrate in a liquid crystal device according to a fourth embodiment.

FIG. 20 is a schematic configuration diagram showing an example of an electronic apparatus including a liquid crystal device.

### DESCRIPTION OF EMBODIMENTS

### First embodiment

A first embodiment of the present disclosure will be described below with reference to the drawings.

In the drawings used in the description below, a characteristic portion is enlarged for convenience in some cases for clarity of the characteristic thereof, and that the dimensional ratio and other factors of each element therefore in some cases differ from actual values.

A liquid crystal device according to the present embodiment is an active-driving-mode transmissive liquid crystal device including a thin film transistor (TFT) as a switching element in each of multiple pixels. The liquid crystal device is used as a light modulator, for example, in a projector that will be described later. The projector in the present embodiment is an example of an electronic instrument.

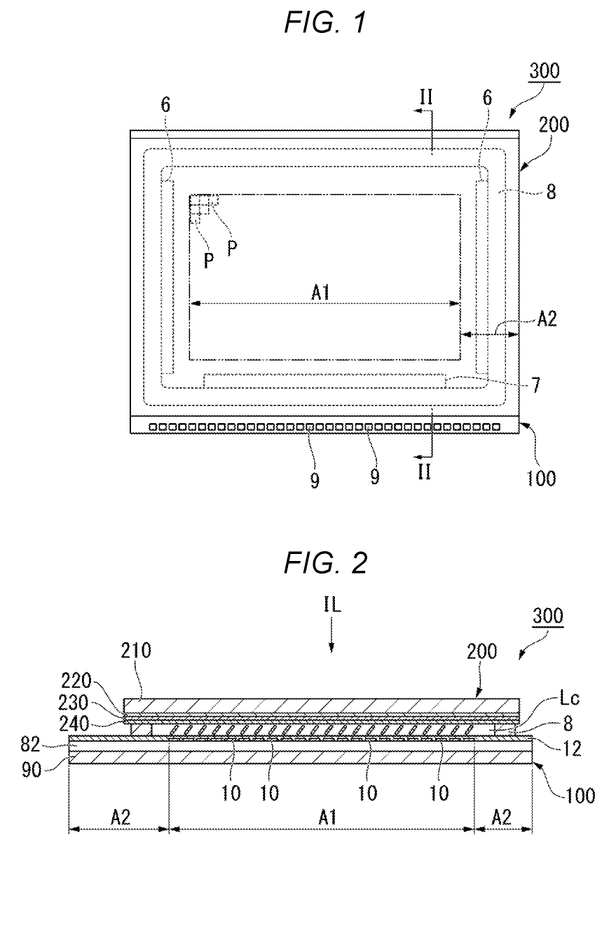

FIG. 1 is a plan view of a liquid crystal device 300. FIG. 2 is a cross-sectional view showing a schematic configuration of the liquid crystal device 300 taken along the line II-II in FIG. 1. An XYZ orthogonal coordinate system is used in the following description, the X-axis being an axis along a horizontal direction of a screen of the liquid crystal device, the Y-axis being an axis along a vertical direction of the screen of the liquid crystal device, and the Z-axis being an axis along the direction of a normal to each substrate that constitutes the liquid crystal device.

The liquid crystal device 300 includes an element substrate 100, a counter substrate 200, a liquid crystal layer Lc interposed between the element substrate 100 and the counter substrate 200, and a sealing member 8, which seals the liquid crystal layer Lc in a space between the element substrate 100 and the counter substrate 200, as shown in FIGS. 1 and 2. The element substrate 100 and the counter substrate 200 are each a light transmissive substrate. Note that the term "light transmissive" means having light transmittance for visible light, and refers to a state in which the transmittance for the visible light is preferably higher than or equal to 50%. The element substrate 100 in the present embodiment corresponds to the first substrate in the claims. The counter substrate 200 in the present embodiment corresponds to the second substrate in the claims.

The liquid crystal device 300 has a display region A1, where an image is displayed, and a circumferential region A2 located outside and around the display region A1 in the plan view. The display region A1 is provided with multiple pixels P arranged in a matrix. Note that the liquid crystal device 300 and the display region A1 shown in FIG. 1 may each have a quadrangular shape, and may instead have another shape, for example, a circular shape.

The element substrate 100 and the counter substrate 200 are disposed to face each other via the liquid crystal layer Lc, as shown in FIG. 2. In the present embodiment, the counter substrate 200 is disposed on the light incident side of the liquid crystal layer Lc. The element substrate 100 is disposed on the light exiting side of the liquid crystal layer Lc. Incident light IL incident on the counter substrate 200 is modulated by the liquid crystal layer Lc and output via the element substrate 100 as modulated light ML.

The element substrate 100 includes a substrate body 90, multiple interlayer insulating layers including an interlayer insulating layer 82, multiple pixel electrodes 10, and an alignment film 12. The substrate body 90 is a light-transmissive, insulating, planar plate. The substrate body 90 is configured, for example, with a glass substrate or a quartz substrate. Although not shown in FIG. 2, transistors 1, various relay layers, various electrically conductive layers, and the like that will be described later are disposed between the multiple interlayer insulating layers.

The pixel electrodes 10 are each configured with a light-transmissive, electrically conductive film. The pixel electrodes 10 are made, for example, of indium tin oxide (ITO). Note that the pixel electrodes 10 are not necessarily made of ITO and may instead each be configured with a transparent electrically conductive film made, for example, of indium zinc oxide (IZO) or tin oxide doped with fluorine (FTO).

The alignment film 12 is made of a light-transmissive, insulating material. The alignment film 12 aligns the liquid crystal molecules in the liquid crystal layer Lc with one another in a predetermined direction. Examples of the material of the alignment film 12 may include silicon oxide (SiO₂), magnesium oxide (MgO), magnesium fluoride (MgF₂), and polyimide. In the present embodiment, to cause the alignment film 12 to function as a vertical alignment film, it is desirable to form the alignment film 12 by using oblique deposition of an inorganic material such as SiO₂,MgO, or MgF₂.

The counter substrate 200 includes a substrate body 210, an insulating layer 220, a common electrode 230, and an alignment film 240. The substrate body 210 is a light-transmissive, insulating, planar plate, as the substrate body 90 of the element substrate 100. The substrate body 210 is configured, for example, with a glass substrate or a quartz substrate. The insulating layer 220 is configured with a light-transmissive, insulating film. The material of the insulating layer 220 is, for example, an inorganic material such as silicon oxide.

The common electrode 230 is an electrode disposed to face the multiple pixel electrodes 10, and is also called a counter electrode. The common electrode 230 is configured with a transparent electrically conductive film made, for example, of ITO, IZO, or FTO. The common electrode 230 and each of the pixel electrodes 10 apply an electric field to the liquid crystal layer Lc. The electric field applied to the space between the common electrode 230 and each of the pixel electrodes 10 is hereinafter referred to as a longitudinal electric field for convenience of the description. The alignment film 240 is made of a light-transmissive, insulating material. The material of which the alignment film 240 is made is the same material of which the alignment film 12 is made.

The sealing member 8 is disposed between the element substrate 100 and the counter substrate 200. The sealing member 8 is made, for example, of an adhesive containing any of various curable resins such as an epoxy resin. The sealing member 8 may contain a gap material made of an inorganic material such as glass in order to maintain a fixed gap between the element substrate 100 and the counter substrate 200.

The liquid crystal layer Lc is sealed in the space surrounded by the element substrate 100, the counter substrate 200, and the sealing member 8. The liquid crystal layer Lc is an electro-optical layer having optical characteristics that changes in accordance with the longitudinal electric field generated by each of the pixel electrodes 10 and the common electrode 230. The liquid crystal layer Lc in the present embodiment is a vertical-alignment-mode liquid crystal layer containing liquid crystal molecules having negative dielectric anisotropy. The alignment of the liquid crystal molecules changes in accordance with the electric fields applied to the liquid crystal layer Lc. The liquid crystal layer Lc modulates the incident light IL in accordance with the applied electric fields.

Multiple scan line driving circuits 6, a data line driving circuit 7, and external coupling terminals 9 are disposed in the circumferential region A2 of the element substrate 100, as shown in FIG. 1. The external coupling terminals 9 are terminals on which external coupling lines such as flexible printed circuits (FPCs) that are not shown are mounted. Various signals such as an image signal, a synch signal, an inspection signal, common potential, and power supply potential are externally supplied to the external coupling terminals 9 via the external coupling lines.

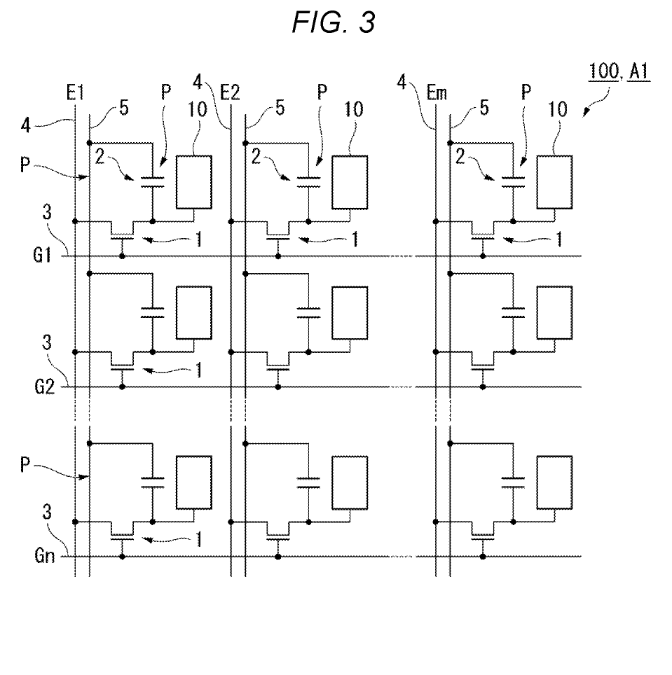

FIG. 3 is an equivalent circuit diagram showing the electrical configuration of the element substrate 100.

Multiple transistors 1, multiple scan lines 3, multiple data lines 4, multiple capacitance lines 5, the multiple pixel electrodes 10, and multiple capacitive elements 2 are provided in the display region A1 of the element substrate 100, as shown in FIG. 3.

The transistors 1 are provided in correspondence with the intersections of the multiple scan lines 3 and the multiple data lines 4. The pixel electrodes 10 are electrically coupled to drain regions of the transistors 1. The multiple scan lines 3 extend in the X-axis direction, and are arranged at equal intervals in the Y-axis direction. The multiple scan lines 3 are each electrically coupled to the gate electrode of the corresponding transistor 1. The multiple scan lines 3 are electrically coupled to the scan line driving circuits 6 shown in FIG. 1. The scan line driving circuits 6 supply scan signals G1, G2,..., Gn to the multiple scan lines 3 sequentially on a line basis.

The multiple data lines 4 extend in the Y-axis direction, and are arranged at equal intervals in the X-axis direction. The multiple data lines 4 are each electrically coupled to a source region of the corresponding one of the multiple transistors 1. The multiple data lines 4 are electrically coupled to the data line driving circuit 7 shown in FIG. 1. The data line driving circuit 7 supplies image signals E1, E2,..., and Em to the multiple data lines 4.

The multiple scan lines 3 and the multiple data lines 4 are electrically insulated from each other, and are arranged in a grid pattern in the plan view. The region surrounded by two adjacent scan lines 3 and two adjacent data lines 4 corresponds to a pixel P.

The multiple capacitance lines 5 extend in the Y-axis direction, and are arranged at equal intervals in the X-axis direction. The capacitance lines 5 are electrically insulated from the data lines 4 and the scan lines 3, and are arranged at intervals away from the data lines 4 and the scan lines 3. Fixed potential such as the common potential or ground potential is supplied to the capacitance lines 5 via the external coupling terminals 9.

One electrode of each of the capacitive elements 2 is electrically coupled to the corresponding capacitance line 5. The other electrode of each of the capacitive elements 2 is electrically coupled to the corresponding pixel electrode 10 and holds the potential of the image signal supplied to the pixel electrode 10. In the present embodiment, the one electrode of each of the capacitive elements 2 is the capacitance line 5, and the other electrode of the capacitive element 2 is a relay layer that electrically couples the pixel electrode 10 and the transistor 1 to each other, as will be described later.

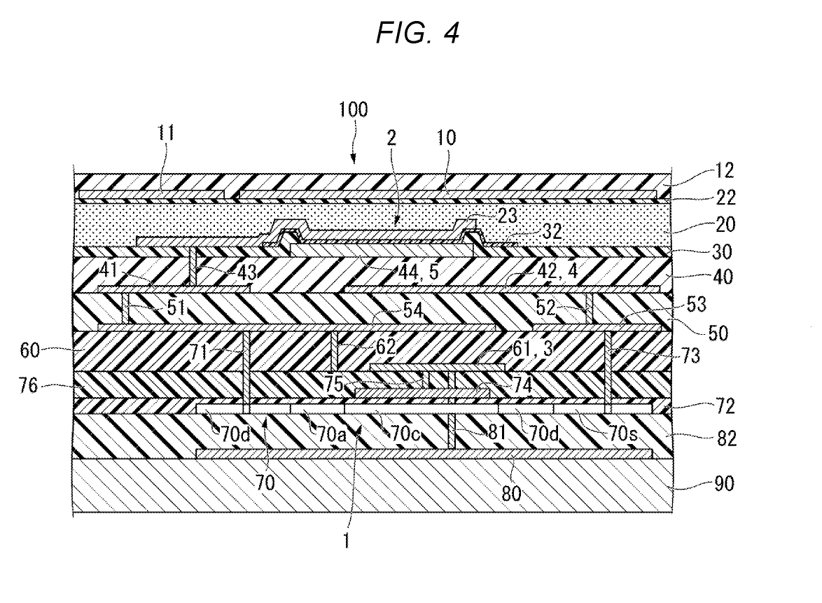

FIG. 4 illustrates a cross-sectional structure of the display region A1 of the element substrate 100, and is a cross-sectional view showing how layers are stacked on each other and how the layers are electrically coupled to each other.

The element substrate 100 has a cross-sectional structure in which insulating or electrically conductive functional layers or films are stacked on the substrate body 90 in the display region A1, as shown in FIG. 4.

A light blocking layer 80 is provided between the substrate body 90 and the interlayer insulating layer 82. The light blocking layer 80 is made of an electrically conductive, light blocking material. Examples of the electrically conductive, light blocking material include metals such as tungsten (W), titanium (Ti), chromium (Cr), iron (Fe), and aluminum (Al), and metal materials such as metal nitrides and metal silicides. The electrically conductive, light blocking material hereinafter functions as a light blocking layer. Note that the term "light blocking" means blocking visible light, and refers to a state in which the transmittance for the visible light is preferably lower than 50 %, more preferably, lower than or equal to 10 %.

The interlayer insulating layer 82 is made of a light-transmissive, insulating material. The interlayer insulating layer 82 is made of an inorganic material such as silicon oxide (SiO₂). In the following description, the other interlayer insulating layers are made of the same material of which the interlayer insulating layer 82 is made.

The transistors 1 are provided on the interlayer insulating layer 82. The transistors 1 each include a semiconductor layer 70 having a lightly doped drain (LDD) structure, a gate electrode 74, and a gate insulating layer 72. The semiconductor layer 70 has a drain region 70d, an LDD region 70a, a channel region 70c, an LDD region 70b, and a source region 70s. The channel region 70c is located in a central portion of the semiconductor layer 70. The LDD region 70b is located between the channel region 70c and the source region 70s. The LDD region 70a is located between the channel region 70c and the drain region 70d.

The semiconductor layer 70 is made, for example, of polysilicon, and a region excluding the channel region 70c is doped with an impurity that increases electrical conductivity. The impurity concentrations in the LDD region 70b and the LDD region 70a are lower than those in the source region 70s and the drain region 70d.

The gate electrode 74 is provided over the semiconductor layer 70 via the gate insulating layer 72. The gate electrode 74 is made, for example, of polysilicon doped with an impurity that increases electrical conductivity. Note that the gate electrode 74 may be made of an electrically conductive material such as metal, metal silicide, or a metal compound. The gate insulating layer 72 is made, for example, of silicon oxide deposited by thermal oxidation, chemical vapor deposition (CVD), or the like.

An interlayer insulating layer 76 is provided on the transistors 1. An electrically conductive layer 61 is provided on the interlayer insulating layer 76. In the present embodiment, the electrically conductive layer 61 functions as the scan line 3. The electrically conductive layer 61 is made of a light blocking, electrically conductive material. The electrically conductive layer 61 is electrically coupled to the gate electrode 74 via a contact hole 75 provided in the interlayer insulating layer 76. The electrically conductive layer 61 is further electrically coupled to the light blocking layer 80 via a contact hole 81 provided in the interlayer insulating layers 76 and 82. The scan signal is supplied from the electrically conductive layer 61 to the light blocking layer 80, which then functions as a back gate.

A light blocking member 62 is coupled to a relay layer 54, and the potential at the drain region 70d is applied to the light blocking member 62 via a contact hole 71 and the relay layer 54. The relay layer 54 is electrically coupled to the drain region 70d of the semiconductor layer 70 via the contact hole 71 provided in an interlayer insulating layer 60 and the interlayer insulating layer 76. A relay layer 53 is electrically coupled to the source region 70s of the semiconductor layer 70 via a contact hole 73 provided in the interlayer insulating layers 60 and 76.

An interlayer insulating layer 50 is provided on the relay layers 53 and 54. A relay layer 41 and an electrically conductive layer 42 are provided on the interlayer insulating layer 50. In the present embodiment, the electrically conductive layer 42 functions as the data line 4. The relay layer 41 and the electrically conductive layer 42 are provided at the same level and are each made of a light-blocking, electrically conductive material.

The relay layer 41 is electrically coupled to the relay layer 54 via a contact hole 51. The electrically conductive layer 42 is electrically coupled to the relay layer 53 via a contact hole 52. An interlayer insulating layer 40 is provided on the relay layer 41, the electrically conductive layer 42, and the interlayer insulating layer 50. An electrically conductive layer 44 and an interlayer insulating layer 30 are provided on the interlayer insulating layer 40. A capacitive insulating layer 32 and an upper capacitive electrode 23 are provided on the electrically conductive layer 44 and the interlayer insulating layer 30. In the present embodiment, the electrically conductive layer 44 functions as the capacitance line 5 (lower capacitive electrode). The electrically conductive layer 44 is made of a light-blocking, electrically conductive material. The upper capacitive electrode 23 is a light-blocking layer made of a light-blocking, electrically conductive material and located at a position closest to the pixel electrode 10. In the present embodiment, the upper capacitive electrode 23 also functions as a light reflection layer.

The electrically conductive layer 44, the upper capacitive electrode 23, and the capacitive insulating layer 32 constitute the capacitive element 2. More specifically, a portion where the electrically conductive layer 44 and the upper capacitive electrode 23 face each other only via the capacitive insulating layer 32 is the capacitive element 2. The capacitive insulating layer 32 is provided between the electrically conductive layer 44 and the upper capacitive electrode 23. The upper capacitive electrode 23 is electrically coupled to the relay layer 41 via a contact hole 43 provided in the interlayer insulating layers 30 and 40.

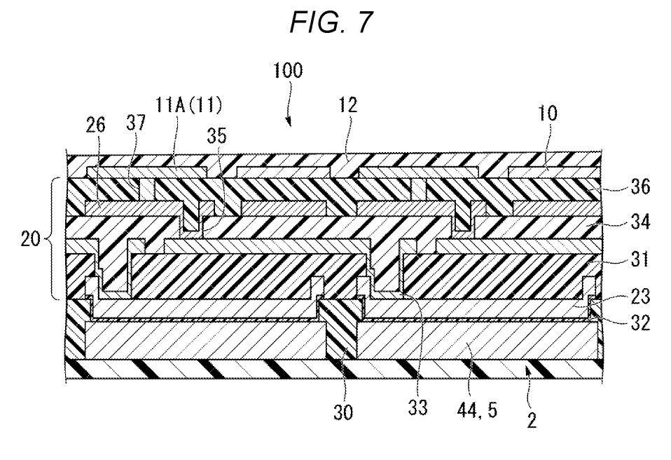

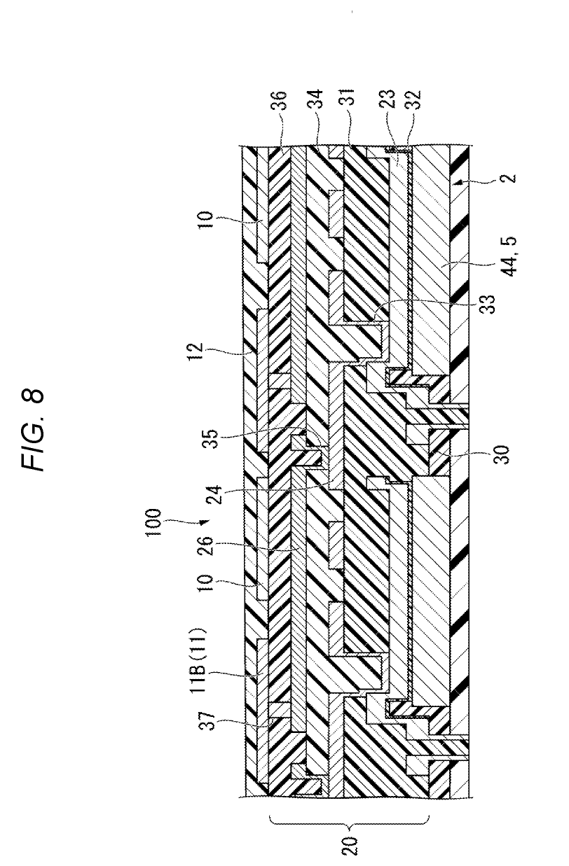

An insulating layer, a relay layer 20, and a protective layer 22 are provided on the upper capacitive electrode 23, the capacitive insulating layer 32, and the interlayer insulating layer 30. The insulating layer and the relay layer 20 will be described in detail later with reference to FIGS. 7 and 8, but are not shown in FIG. 4. The protective layer 22 is made of a light-transmissive, hygroscopic inorganic material, for example, borosilicate glass (BSG). The protective layer 22 may not be formed.

The pixel electrode 10 and liquid crystal alignment control electrodes 11 are provided on the protective layer 22. The pixel electrode 10 is electrically coupled to the upper capacitive electrode 23 via a configuration that will be described later. In the present embodiment, out of the multiple pixel electrodes 10 and the multiple liquid crystal alignment control electrodes 11 located in the display region A1, one pixel electrode 10 and two liquid crystal alignment control electrodes 11 are electrically coupled to each other. This point will be described later. The alignment film 12 is provided on the pixel electrodes 10 and the liquid crystal alignment control electrodes 11.

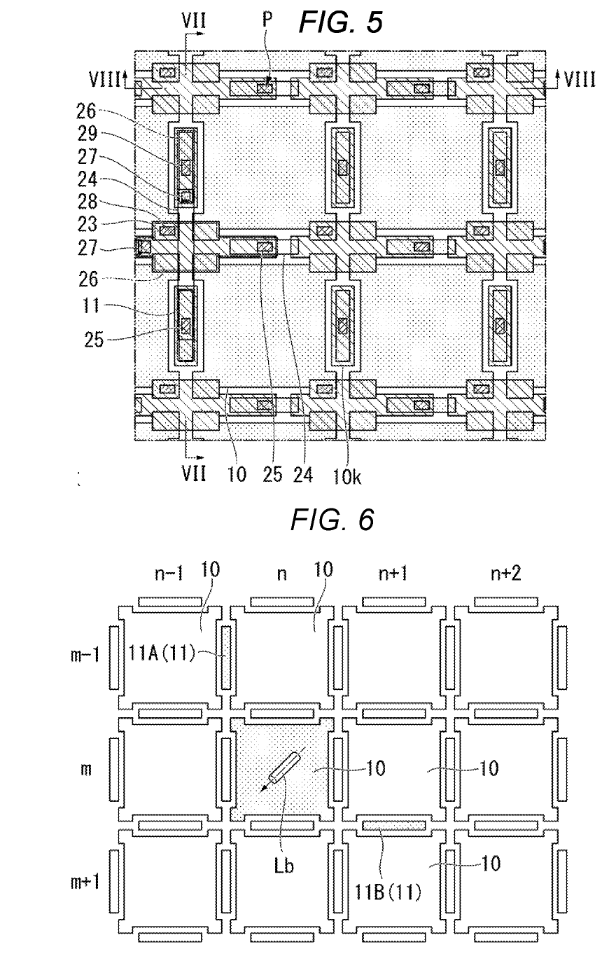

FIG. 5 is a plan view showing a pattern shape of each of the layers that constitute the element substrate 100. Note, however, that FIG. 5 shows only patterns above the upper capacitive electrode 23 that are characteristic portions of the present embodiment.

The upper capacitive electrode 23, which is a substantially L-shaped electrode, is provided in correspondence with each of the pixels P, as shown in FIG. 5. A first relay electrode 24 is provided at each of a position where the first relay electrode 24 overlaps with a portion of the upper capacitive electrode 23 that is the portion extending in the X-axis direction, and a position where the first relay electrode 24 overlaps with a portion of the upper capacitive electrode 23 that is the portion extending in the Y-axis direction. A contact hole 25, which electrically couples each of the first relay electrodes 24 to the upper capacitive electrode 23, is provided at a position where the first relay electrode 24 overlaps with the upper capacitive electrode 23.

A second relay electrode 26 is provided at each of a position where the second relay electrode 26 overlaps with a portion of the upper capacitive electrode 23 that is the portion extending in the X-axis direction, and a position where the second relay electrode 26 overlaps with a portion of the upper capacitive electrode 23 that is the portion extending in the Y-axis direction. A contact hole 27, which electrically couples each of the second relay electrodes 26 to the upper capacitive electrode 23, is provided at a position where the second relay electrode 26 overlaps with the upper capacitive electrode 23.

The multiple liquid crystal alignment control electrodes 11 are each provided between two pixel electrodes 10 adjacent to each other in each of the X-axis direction and the Y-axis direction out of the multiple pixel electrodes 10. The pixel electrodes 10 each have a substantially square shape. At each of the four sides of each of the pixel electrodes 10, a rectangular cutout 10k is provided at the center of the side, and the liquid crystal alignment control electrodes 11 each having a rectangular shape are each disposed in the cutout 10k between two pixel electrodes 10 adjacent to each other. The pixel electrodes 10 and the liquid crystal alignment control electrodes 11 are arranged at predetermined intervals so as not to be short-circuited to each other.

A contact hole 28, which electrically couples each of the second relay electrodes 26 to the corresponding pixel electrode 10, is provided at a position where the second relay electrode 26 overlaps with the pixel electrode 10. A contact hole 29, which electrically couples each of the second relay electrodes 26 to the corresponding liquid crystal alignment control electrode 11, is provided at a position where the second relay electrode 26 overlaps with the liquid crystal alignment control electrode 11. The liquid crystal alignment control electrode 11 and the pixel electrode 10 are thus electrically coupled to each other via the second relay electrodes 26. Therefore, when a voltage is applied to a specific pixel electrode 10, the same voltage applied to the pixel electrode 10 is also applied to the liquid crystal alignment control electrode 11 electrically coupled to the pixel electrode 10.

The positional relationship between the pixel electrodes 10 and the liquid crystal alignment control electrodes 11 electrically coupled to each other will be described below.

FIG. 6 is a diagrammatic view showing an electrical coupling relationship between the pixel electrodes 10 and the liquid crystal alignment control electrodes 11. FIG. 6 shows pixel electrodes 10 in three rows and four columns out of the multiple pixel electrodes 10 arranged in a matrix in the display region A1. In the present specification, a group of the pixel electrodes arranged in the horizontal direction (X-axis direction) of the display region A1 is referred to as a row, and a group of the pixel electrodes arranged in the vertical direction (Y-axis direction) is referred to as a column. In FIG. 6, it is assumed that three rows are referred to as an (m−1)-th row, an m-th row, and an (m+1)-th row sequentially from the upper row (+Y side) to the lower row (−Y side). It is further assumed that four columns are referred to as an (n−1)-th column, an n-th column, an (n+1)-th column, and an (n+2)-th column sequentially from the left column (−X side) to the right column (+X side). The constants m and n are integers greater than or equal to one.

Two of the multiple liquid crystal alignment control electrodes 11 are electrically coupled to one of the multiple pixel electrodes 10, as shown in FIG. 6. Note that the hatched electrodes in FIG. 6 are electrically coupled to each other. Specifically, the liquid crystal alignment control electrode 11 located between the pixel electrode 10 located in the (m−1)-th row and the (n−1)-th column and the pixel electrode 10 located in the (m−1)-th row and the n-th column, and the liquid crystal alignment control electrode 11 located between the pixel electrode 10 located in the m-th row and the (n+1)-th column and the pixel electrode 10 located in the (m+1)-th row and the (n+1)-th column are electrically coupled to the pixel electrode 10 located in the m-th row and the n-th column. Although the description has been made focusing on the pixel electrode 10 located in the m-th row and the n-th column, all the pixel electrodes 10 are each electrically coupled to two liquid crystal alignment control electrodes 11 having the same positional relationship described above.

In the following description, the liquid crystal alignment control electrode 11 located between the pixel electrode 10 located in the (m−1)-th row and the (n−1)-th column and the pixel electrode 10 located in the (m−1)-th row and the n-th column, that is, the liquid crystal alignment control electrode 11 located at a position shifted in the Y-axis direction from the pixel electrode 10 located in the m-th row and the n-th column is referred to as a first liquid crystal alignment control electrode 11A for convenience of description. The first liquid crystal alignment control electrode 11A has a strip shape extending along sides of the two adjacent pixel electrodes 10 in the (m−1)-th row that are the sides facing each other. The liquid crystal alignment control electrode 11 located between the pixel electrode 10 located in the m-th row and the (n+1)-th column and the pixel electrode 10 located in the (m+1)-th row and the (n+1)-th column, that is, the liquid crystal alignment control electrode 11 located at a position shifted in the X-axis direction from the pixel electrode 10 located in the m-th row and the n-th column is referred to as a second liquid crystal alignment control electrode 11B. The second liquid crystal alignment control electrode 11B has a strip shape extending along sides of the two adjacent pixel electrodes 10 in the (n+1)-th column that are the sides facing each other.

In the case described above, it is assumed that the azimuth angle direction of the pre-tilted liquid crystal molecules is the direction in which the pixel electrode 10 located in the (m+1)-th row and the (n−1)-th column, the pixel electrode 10 located in the m-th row and the n-th column, and the pixel electrode 10 located in the (m−1)-th row and the (n+1)-th column are arranged. The azimuth angle direction of the pre-tilted liquid crystal molecules is defined as the direction of the major axis of liquid crystal molecules Lb to which no voltage is applied when viewed from the direction perpendicular to the element substrate 100. Therefore, in other words, when viewed from the direction perpendicular to the element substrate 100, the direction of the major axis of the liquid crystal molecules Lb to which no voltage is applied is the direction from the upper right toward the lower left in FIG. 6. Contrary to the above, when the azimuth angle direction of the pre-tilted liquid crystal molecules is the direction from the upper left toward the lower right in FIG. 6, the positional relationship between the two liquid crystal alignment control electrodes 11A and 11B electrically coupled to the pixel electrode 10 located in the m-th row and the n-th column is the positional relationship obtained by reversing the plane of view of FIG. 6.

A specific cross-sectional structure that realizes electrical coupling between a pixel electrode 10 and liquid crystal alignment control electrodes 11 will be described below.

FIG. 7 is a cross-sectional view of the element substrate 100 taken along the line VII-VII in FIG. 5. FIG. 8 is a cross-sectional view of the element substrate 100 taken along the line VIII-VIII in FIG. 5.

In the present embodiment, the liquid crystal alignment control electrodes 11 and the pixel electrodes 10 are configured with electrically conductive films provided at the same level, as shown in FIGS. 7 and 8.

The pixel electrode 10 and the first liquid crystal alignment control electrode 11A are coupled to the upper capacitive electrode 23 via one of the first relay electrodes 24 and one of the second relay electrodes 26 and therefore electrically coupled to each other, as shown in FIG. 7. The pixel electrode 10 and the second liquid crystal alignment control electrode 11B are coupled to the upper capacitive electrode 23 via the other first relay electrode 24 and the other second relay electrode 26 and therefore electrically coupled to each other, as shown in FIG. 8.

Specifically, regarding the electrical coupling between the pixel electrode 10 and the first liquid crystal alignment control electrode 11A, the upper capacitive electrode 23 and the one first relay electrode 24 are coupled to each other via a first contact hole 33 provided in a first interlayer insulating film 31, which covers the upper capacitive electrode 23, as shown in FIG. 7. The one first relay electrode 24 extends in the Y-axis direction to be coupled to the first liquid crystal alignment control electrode 11A located at a position separate from the pixel electrode 10 in the Y-axis direction. The one first relay electrode 24 and the one second relay electrode 26 are coupled to each other via a second contact hole 35 provided in a second interlayer insulating film 34, which covers the one first relay electrode 24. The one second relay electrode 26 and the first liquid crystal alignment control electrode 11A are coupled to each other via a third contact hole 37 provided in a third interlayer insulating film 36, which covers the one second relay electrode 26.

Regarding the electrical coupling between the pixel electrode 10 and the second liquid crystal alignment control electrode 11B, the upper capacitive electrode 23 and the other first relay electrode 24 are coupled to each other via another first contact hole 33 provided in the first interlayer insulating film 31, which covers the upper capacitive electrode 23, as shown in FIG. 8. The other first relay electrode 24 and the other second relay electrode 26 are coupled to each other via another second contact hole 35 provided in the second interlayer insulating film 34, which covers the other first relay electrode 24. The other second relay electrode 26 extends in the X-axis direction to be coupled to the second liquid crystal alignment control electrode 11B located at a position separate from the pixel electrode 10 in the X-axis direction. The other second relay electrode 26 and the second liquid crystal alignment control electrode 11B are coupled to each other via another third contact hole 37 provided in the third interlayer insulating film 36, which covers the other second relay electrode 26.

### Advantages of first embodiment

A mechanism in accordance with which the reverse tilt domain occurs in the liquid crystal device of related art will be described.

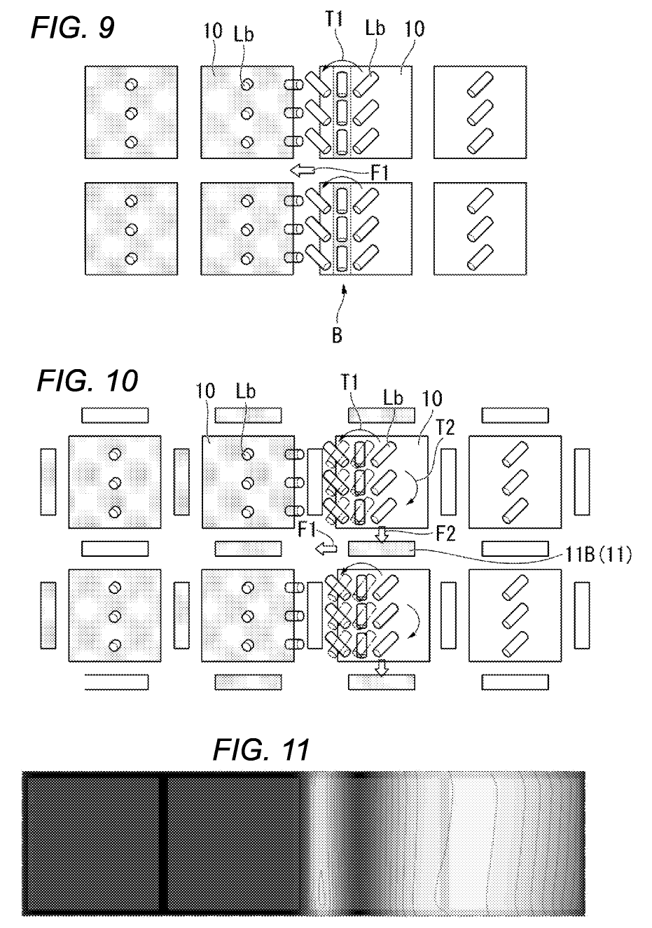

FIG. 9 is a diagrammatic view showing the mechanism that generates the reverse tilt domain. FIG. 9 shows only eight pixels in two rows and four columns out of the multiple pixels of the liquid crystal device.

For example, to display a line extending in the vertical direction (Y-axis direction) of the screen, 0 V is applied to the pixel electrodes 10 in the two columns on the left, so that the liquid crystal molecules Lb stand in a direction substantially perpendicular to the substrate surfaces (plane of view of FIG. 9) and the pixels are therefore displayed in black, as shown in FIG. 9. In contrast, 5 V is applied to the pixel electrodes 10 in the two columns on the right, so that the liquid crystal molecules Lb tilt in parallel to the substrate surfaces and the pixels are therefore displayed in white. In this case, a 5-V electric field F1 is generated between the pixel electrode 10 in the second column from the left and the pixel electrode 10 in the third column from the left. An electric field generated between two adjacent pixel electrodes 10 is hereinafter referred to as a lateral electric field for convenience of the description. The lateral electric field F1 generates a first torque T1, which is a rotational force that rotates the liquid crystal molecules Lb counterclockwise. When the rotational force, which is the first torque T1, is generated, the liquid crystal molecules Lb located near the boundary between the pixel electrode 10 in the second column from the left and the pixel electrode 10 in the third column from the left rotate counterclockwise. As a result, a reverse tilt domain in which the major axis of the liquid crystal molecules Lb is oriented in an azimuth angle direction different from the original azimuth angle direction occurs, resulting in a problem of a linear black portion B displayed in a portion of the pixels that should be displayed in white.

In contrast, FIG. 10 is a diagrammatic view showing an example of a mechanism in the present embodiment that solves the reverse tilt domain. FIG. 10 shows a case where the second liquid crystal alignment control electrode 11B out of the two liquid crystal alignment control electrodes 11A and 11B provides the effect of solving the reverse tilt domain.

In the liquid crystal device according to the present embodiment, to display a black line extending in the vertical direction (Y-axis direction) of the screen, for example, 0 V is applied to the pixel electrode 10 in the first row and the second column from the left, and 5 V is applied to the pixel electrode 10 in the first row and the third column from the left, as shown in FIG. 10. In this process, 0 V is applied to the second liquid crystal alignment control electrode 11B located on the lower side (−Y side) of the pixel electrode 10 in the first row and the third column from the left since the second liquid crystal alignment control electrode 11B is electrically coupled to the pixel electrode 10 in the first row and the second column from the left. A 5-V lateral electric field F2 is also generated between the pixel electrode 10 in the first row and the third column from the left and the second liquid crystal alignment control electrode 11B on the lower side of the pixel electrode. The lateral electric field F2 is an electric field that is perpendicular to the +Y direction, in which the lateral electric field F1 described above, which generates the first torque T1, is generated, and is oriented toward the negative side in the Z direction, where the second liquid crystal alignment control electrode 11B is located with respect to the pixel electrode 10 in the first row and the third column from the left, where the reverse tilt domain may occur. As described above, in the pixel electrode 10 in the first row and the third column from the left, the lateral electric field F2, which is oriented in the direction in which the pixel electrode 10 and the second liquid crystal alignment control electrode 11B are arranged, generates the second torque T2, which is a rotational force that rotates the liquid crystal molecules Lb clockwise, in addition to the rotational force that is the first torque T1 generated by the lateral electric field F1 described above. As a result, since the first torque T1 is canceled by the second torque T2 acting in the direction opposite the direction in which the first torque T1 acts, the counterclockwise rotation of the liquid crystal molecules Lb indicated by the two-dot chain line in FIG. 10 is less likely to occur, so that the display failure due to the reverse tilt domain can be reduced. Since the second liquid crystal alignment control electrode 11B has a strip shape extending along sides of the adjacent pixel electrodes 10 that are the sides facing each other, the lateral electric field F2 is generated along the entire sides of the pixel electrodes 10, so that the display failure due to the reverse tilt domain can be efficiently reduced.

The present inventor conducted a simulation that demonstrates the effect of reducing the display failure due to the reverse tilt domain that occurs in the liquid crystal device according to the present embodiment.

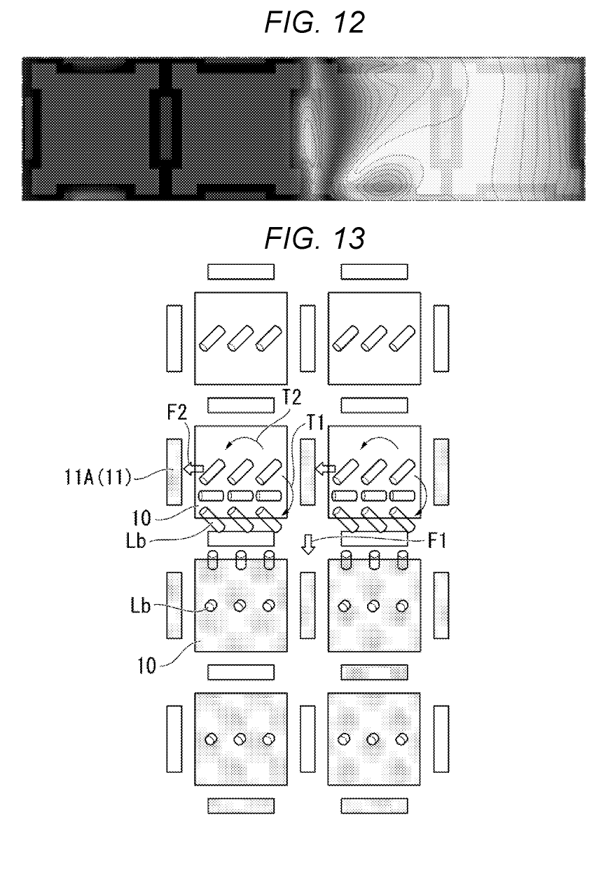

FIG. 11 shows a result of the simulation of the reverse tilt domain in the case of the related art, where no liquid crystal alignment control electrodes are provided. FIG. 12 shows a result of the simulation of the reverse tilt domain in the present embodiment, in which the liquid crystal alignment control electrodes are provided.

The inventor of the present disclosure modeled four pixels arranged in the horizontal direction in each of the liquid crystal device of the related art and the liquid crystal device of the present embodiment, and simulated occurrence of the reverse tilt domain with voltages of 0 V, 0 V, 5 V, and 5 V applied sequentially from the pixel electrode on the left toward the pixel electrode on the right.

In the liquid crystal device of the related art, a linear black portion due to the reverse tilt domain is clearly visually recognized inside the third pixel from the left, as shown in FIG. 11. In contrast, in the liquid crystal device of the present embodiment, the black portion due to the reverse tilt domain is small at an end portion of the pixel, as shown in FIG. 12. As described above, the liquid crystal device of the present embodiment demonstrated that the portion displayed in black due to the reverse tilt domain is unlikely to be visually recognized.

FIG. 13 is a diagrammatic view showing another example of the mechanism in the present embodiment that solves the reverse tilt domain. FIG. 13 shows a case where the first liquid crystal alignment control electrode 11A out of the two liquid crystal alignment control electrodes 11A and 11B provides the effect of solving the reverse tilt domain.

In the liquid crystal device according to the present embodiment, to display a black line extending in the horizontal direction of the screen (X-axis direction), for example, 0 V is applied to the left pixel electrode 10 in the third row, and 5 V is applied to the left pixel electrode 10 in the second row, as shown in FIG. 13. In this process, 0 V is applied to the first liquid crystal alignment control electrode 11A located on the left side (−X side) of the left pixel electrode 10 in the second row since the first liquid crystal alignment control electrode 11A is electrically coupled to the left pixel electrode 10 in the third row. The 5-V lateral electric field F2 is also generated between the left pixel electrode 10 in the second row and the first liquid crystal alignment control electrode 11A on the left of the pixel electrode 10. As a result, in addition to the first torque T1, which is a rotational force that rotates the liquid crystal molecules Lb clockwise, the lateral electric field F2 generates the second torque T2, which is a rotational force that rotates the liquid crystal molecules Lb counterclockwise. The first torque T1 is therefore cancelled by the second torque T2 acting in the direction opposite the direction in which the first torque T1 acts, so that the display failure due to the reverse tilt domain can be reduced. Since the first liquid crystal alignment control electrode 11A has a strip shape extending along sides of the adjacent pixel electrodes 10 that are the sides facing each other, the lateral electric field F2 is generated along the entire sides of the pixel electrodes 10, so that the display failure due to the reverse tilt domain can be efficiently reduced.

The effect of solving the reverse tilt domain in a case where an object other than a line is displayed will be described below.

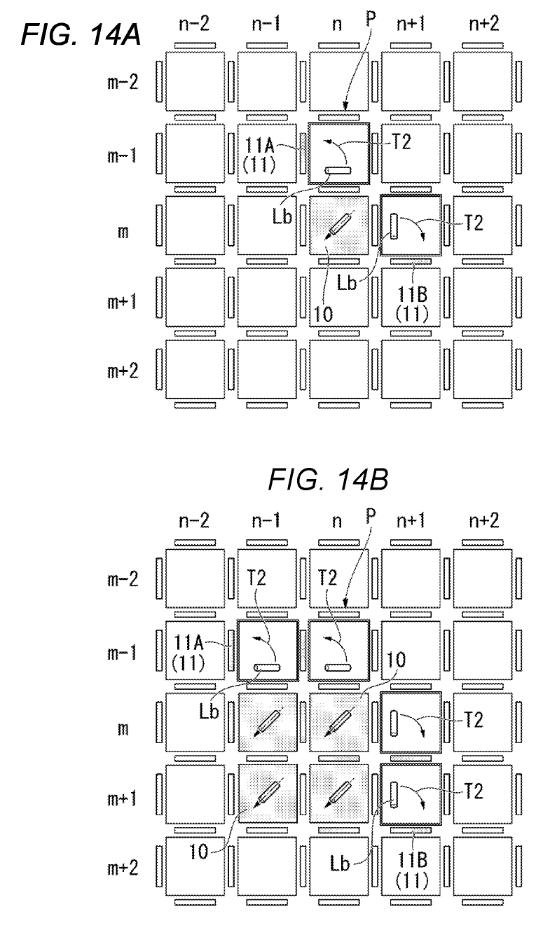

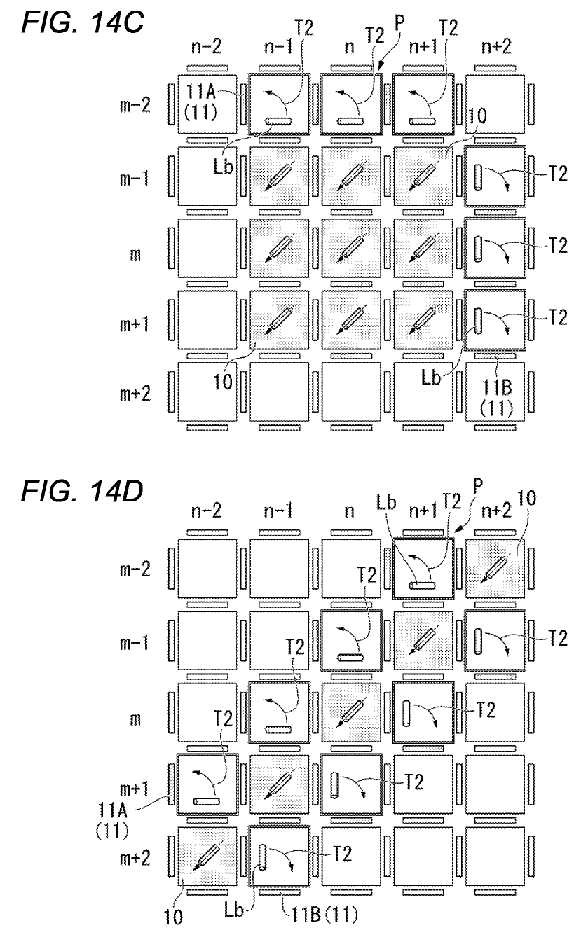

FIG. 14A shows the effect of solving the reverse tilt domain in a case where only one pixel is displayed in black.

When the potential of the pixel electrode 10 in the m-th row and the n-th column is 0 V and the pixel is displayed in black, and the potential of the other pixel electrodes 10 is 5 V and the pixels are displayed in white, the potential of the first liquid crystal alignment control electrode 11A located on the left side (−X side) of the pixel electrode 10 in the (m−1)-th row and the n-th column, and the potential of the second liquid crystal alignment control electrode 11B located on the lower side (−Y side) of the pixel electrode 10 in the m-th row and the (n+1)-th column are both 0 V, as shown in FIG. 14A. The second torque T2, which cancels the first torque T1, is therefore generated in the liquid crystal molecules Lb at the pixel P in the (m−1)-th row and the n-th column and the pixel P in the m-th row and the (n+1)-th column. The display failure due to the reverse tilt domain in these pixels P can therefore be reduced.

FIG. 14B shows the effect of solving the reverse tilt domain in a case where four pixels in two rows and two columns are displayed in black.

When the potential of each of the pixel electrode 10 in the m-th row and the (n−1)-th column, the pixel electrode 10 in the m-th row and the n-th column, the pixel electrode 10 in the (m+1)-th row and the (n−1)-th column, and the pixel electrode 10 in the (m+1)-th row and the n-th column is 0 V so that the pixels are displayed in black, the potential of the first liquid crystal alignment control electrode 11A located on the left side (−X side) of the pixel electrode 10 in the (m−1)-th row and the (n−1)-th column and the pixel electrode 10 in the (m−1)-th row and the n-th column, and the potential of the second liquid crystal alignment control electrode 11B located on the lower side (−Y side) of the pixel electrode 10 in the m-th row and the (n+1)-th column and the pixel electrode 10 in the (m+1)-th row and the (n+1)-th column are both 0 V, as shown in FIG. 14B. The second torque T2, which cancels the first torque T1 described above, is therefore generated in the liquid crystal molecules Lb at the pixel P in the (m-1)-th row and the (n−1)-th column, the pixel P in the (m−1)-th row and the n-th column, the pixel P in the m-th row and the (n+1)-th column, and the pixel P in the (m+1)-th row and the (n+1)-th column. The display failure due to the reverse tilt domain in these pixels P can therefore be reduced.

FIG. 14C shows the effect of solving the reverse tilt domain in a case where nine pixels in three rows and three columns are displayed in black.

Also in this case, the second torque T2, which cancels the first torque T1 described above, is generated in the liquid crystal molecules Lb at the three pixels P located on the upper side (+Y side) of the pixels displayed in black and the three pixels P located on the right side (+X side) of the pixels displayed in black, as shown in FIG. 14C, as in FIG. 14B. The display failure due to the reverse tilt domain in these pixels P can thus be reduced.

FIG. 14D shows the effect of solving the reverse tilt domain in a case where a black line extending in an oblique direction is displayed.

Also in this case, the second torque T2, which cancels the first torque T1 described above, is generated in the liquid crystal molecules Lb at the pixel P located on the left side (−X side) of each of the pixels displayed in black and the pixel P located on the right side (+X side) of each of the pixels displayed in black, as shown in FIG. 14D. The display failure due to the reverse tilt domain in these pixels P can thus be reduced.

As described above, the liquid crystal device 300 according to the present embodiment can reduce the display failure due to the reverse tilt domain even in the case where an object other than a line extending in the vertical direction or the horizontal direction is displayed.

Furthermore, the configuration in the present embodiment, in which two liquid crystal alignment control electrodes 11 located at specific positions with respect to one pixel electrode 10 are electrically coupled to the pixel electrode 10, can generate the second torque T2, which cancels the first torque T1, without providing a switching element in each of the liquid crystal alignment control electrodes 11, so that the display failure due to the reverse tilt domain can be reduced. The wiring structure of the element substrate 100 is therefore not complicated.

Moreover, in the configuration in the present embodiment, the liquid crystal alignment control electrodes 11 and the pixel electrodes 10 are configured with electrically conductive films provided at the same level. The configuration described above, in which the liquid crystal alignment control electrodes 11 and the pixel electrodes 10 can be simultaneously formed in one step, can simplify the manufacturing process.

### Second embodiment

A second embodiment of the present disclosure will be described below with reference to the drawings.

The basic configuration of the liquid crystal device according to the present embodiment is the same as that of the liquid crystal device according to the first embodiment. The basic configuration of the liquid crystal device will therefore be omitted.

The present embodiment differs from the first embodiment in the positional relationship between the two liquid crystal alignment control electrodes electrically coupled to one pixel electrode.

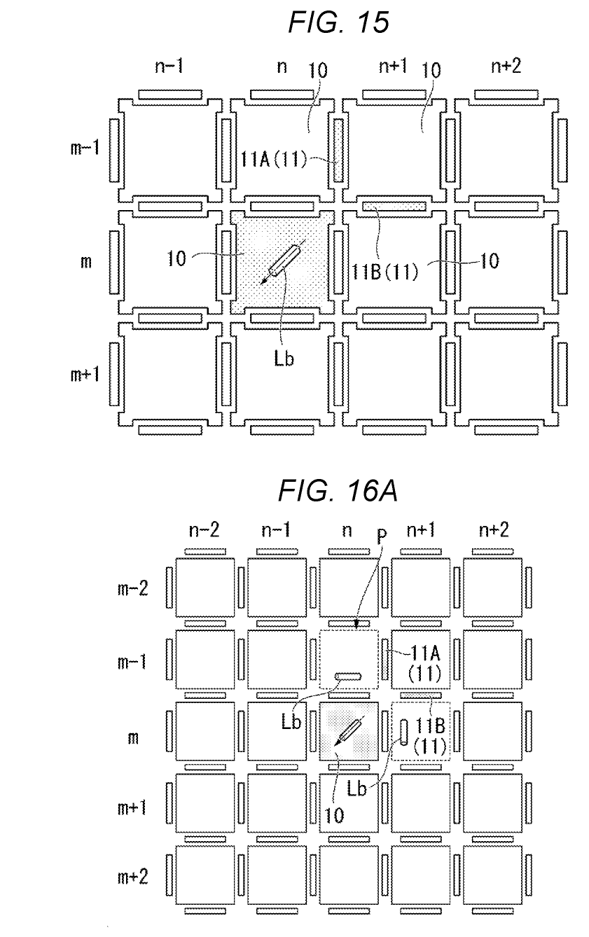

FIG. 15 is a diagrammatic view showing the electrical coupling relationship between the pixel electrodes 10 and the liquid crystal alignment control electrodes 11 in the liquid crystal device according to the present embodiment. In FIG. 15, elements common to those in the drawings referred to in the first embodiment have the same reference characters.

The two liquid crystal alignment control electrodes 11A and 11B out of the multiple liquid crystal alignment control electrodes 11 are electrically coupled to one of the multiple pixel electrodes 10, as shown in FIG. 15. Specifically, the first liquid crystal alignment control electrode 11A located between the pixel electrode 10 located in the (m−1)-th row and the n-th column and the pixel electrode 10 located in the (m−1)-th row and the (n+1)-th column, and the second liquid crystal alignment control electrode 11B located between the pixel electrode 10 located in the (m−1)-th row and the (n+1)-th column and the pixel electrode 10 located in the m-th row and the (n+1)-th column are electrically coupled to the pixel electrode 10 located in the m-th row and the n-th column. Although the description has been made focusing on the pixel electrode 10 located in the m-th row and the n-th column, all the pixel electrodes 10 are each electrically coupled to two liquid crystal alignment control electrodes 11 having the same positional relationship described above.

Other elements of the liquid crystal device are substantially the same as those of the liquid crystal device according to the first embodiment.

### Advantages of second embodiment

In the liquid crystal device according to the present embodiment, to display a black line extending in the vertical direction of the screen (Y-axis direction), for example, 0 V is applied to the pixel electrode 10 located in the m-th row and the n-th column, and 5 V is applied to the pixel electrode 10 located in the m-th row and the (n+1)-th column. In this process, 0 V is applied to the second liquid crystal alignment control electrode 11B located on the lower side (−Y side) of the pixel electrode 10 located in the m-th row and in the (n+1)-th column since the second liquid crystal alignment control electrode 11B is electrically coupled to the pixel electrode 10 located in the m-th row and in the n-th column. Therefore, in addition to the first torque, which causes the reverse tilt domain, the second torque, which attempts to rotate the liquid crystal molecules Lb in the direction opposite the direction in which the first torque attempts to rotate the liquid crystal molecules Lb, is generated, as in FIG. 10 referred to in the first embodiment. As a result, the first torque is cancelled by the second torque, so that the display failure due to the reverse tilt domain can be reduced. Furthermore, when a black line extending in the horizontal direction (X-axis direction) of the screen is displayed, the same effect shown in FIG. 13 and provided by the first embodiment occurs, so that the same advantage can be provided.

The effect of solving the reverse tilt domain in a case where an object other than a line is displayed will be described below.

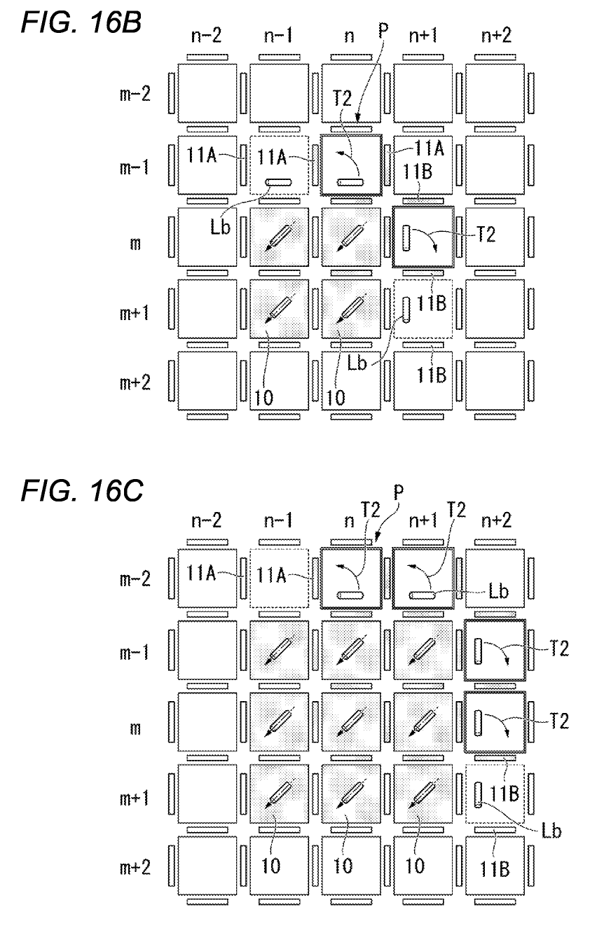

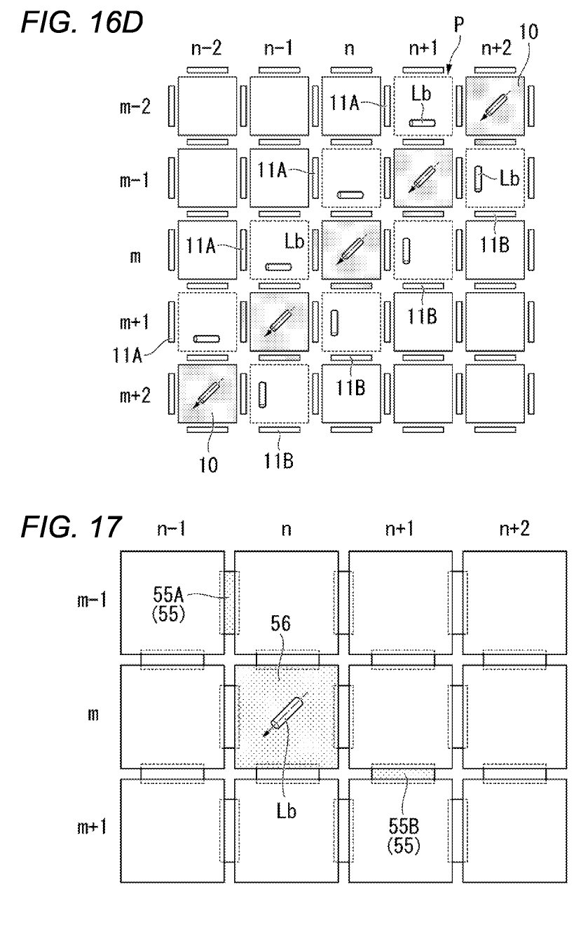

FIG. 16A shows the effect of solving the reverse tilt domain in the case where only one pixel is displayed in black.

When the potential of the pixel electrode 10 in the m-th row and the n-th column is 0 V and the pixel is displayed in black, the potential of the first liquid crystal alignment control electrode 11A located on the right side (+X side) of the pixel electrode 10 in the (m−1)-th row and the n-th column, and the potential of the second liquid crystal alignment control electrode 11B located on the upper side (+Y side) of the pixel electrode 10 in the m-th row and the (n+1)-th column are both 0 V, as shown in FIG. 16A. In this case, the second torque, which acts in the direction opposite the direction in which the first torque described above acts and cancels the first torque, is not generated in the liquid crystal molecules Lb at the pixel P in the (m−1)-th row and the n-th column and the pixel P in the m-th row and the (n+1)-th column. The display failure due to the reverse tilt domain in these pixels P cannot therefore be reduced.

FIG. 16B shows the effect of solving the reverse tilt domain in the case where four pixels in two rows and two columns are displayed in black.

When the potential of each of the pixel electrode 10 in the m-th row and the (n−1)-th column, the pixel electrode 10 in the m-th row and the n-th column, the pixel electrode 10 in the (m+1)-th row and the (n−1)-th column, and the pixel electrode 10 in the (m+1)-th row and the n-th column is 0 V so that the pixels are displayed in black, the potential of the first liquid crystal alignment control electrode 11A located on the left side (−X side) of the pixel electrode 10 in the (m−1)-th row and the n-th column and the pixel electrode 10 in the (m−1)-th row and the (n+1)-th column, and the potential of the second liquid crystal alignment control electrode 11B located on the lower side (−Y side) of the pixel electrode 10 in the (m−1)-th row and the (n+1)-th column and the pixel electrode 10 in the m-th row and the (n+1)-th column are both 0 V, as shown in FIG. 16B. However, since the potential of the first liquid crystal alignment control electrode 11A located on the left side (−X side) of the pixel electrode 10 in the (m−1)-th row and the (n−1)-th column does not become 0 V, the second torque T2 is not generated at the pixel in the (m−1)-th row and the (n−1)-th column, so that the display failure due to the reverse tilt domain cannot be reduced. In addition, since the potential at the second liquid crystal alignment control electrode 11B located on the lower side (−Y side) of the pixel electrode 10 in the (m+1)-th row and the (n+1)-th column does not become 0 V, the second torque T2 is not generated at the pixel in the (m+1)-th row and the (n+1)-th column, so that the display failure due to the reverse tilt domain cannot be reduced. In contrast, since the second torque T2 is generated at the pixel P in the (m−1)-th row and the n-th column and the pixel P in the m-th row and the (n+1)-th column, the display failure due to the reverse tilt domain can be reduced.

FIG. 16C shows the effect of solving the reverse tilt domain in the case where nine pixels in three rows and three columns are displayed in black.

Also in this case, the second torque T2 is not generated at the pixel P in the (m−2)-th row and the (n−1)-th column and the pixel P at the (m+1)-th row and the (n+2)-th column, so that the display failure due to the reverse tilt domain cannot be reduced, as shown in FIG. 16C, as in the case shown in FIG. 16B. In contrast, since the second torque T2 is generated at the pixel P in the (m−2)-th row and the n-th column, the pixel P in the (m−2)-th row and the (n+1)-th column, the pixel P in the (m−1)-th row and the (n+2)-th column, and the pixel P in the m-th row and the (n+2)-th column, the display failure due to the reverse tilt domain can be reduced.

FIG. 16D shows the effect of solving the reverse tilt domain in the case where a black line extending in an oblique direction is displayed.

In this case, the second torque, which cancels the first torque, is not generated at any of the pixel P located on the left side (−X side) of each of the pixels displayed in black and the pixel P located on the right side (+X side) of each of the pixels displayed in black, as shown in FIG. 16D. The display failure due to the reverse tilt domain cannot therefore be reduced.

As described above, the liquid crystal device according to the embodiment has pixels where the display failure due to the reverse tilt domain cannot be sufficiently reduced in the case where an object other than a line extending in the vertical direction or the horizontal direction is displayed. In either case, however, the portion displayed in black by the reverse tilt domain is not continuous in the vertical direction or the horizontal direction. The portion displayed in black is therefore unlikely to be visually recognized, and hence does not cause a serious problem.

### Third embodiment

A third embodiment of the present disclosure will be described below with reference to the drawings.

The basic configuration of a liquid crystal device according to the third embodiment is the same as that in the first embodiment, and will therefore not be described.

The present embodiment differs from the first embodiment in the configurations of the pixel electrodes and the liquid crystal alignment control electrodes.

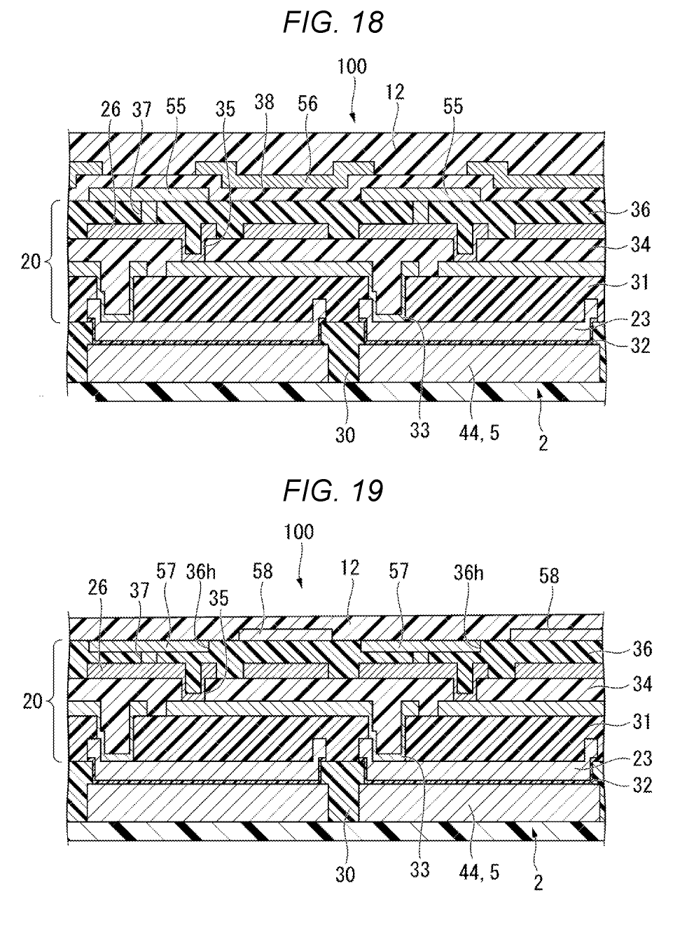

FIG. 17 is a diagrammatic view showing the electrical coupling relationship between the pixel electrodes and the liquid crystal alignment control electrodes in the liquid crystal device according to the present embodiment. FIG. 18 is a cross-sectional view of the element substrate.

In the first embodiment, the liquid crystal alignment control electrodes 11 and the pixel electrodes 10 are configured with electrically conductive films provided at the same level. In contrast, in the present embodiment, liquid crystal alignment control electrodes 55 and pixel electrodes 56 are configured with electrically conductive films provided at levels different from each other, as shown in FIG. 18. Specifically, the liquid crystal alignment control electrodes 55 are provided below the pixel electrodes 56, and the pixel electrodes 56 are provided above the liquid crystal alignment control electrodes 55. An insulating film 38 is interposed between the liquid crystal alignment control electrodes 55 and the pixel electrodes 56.

The pixel electrodes 56 are each configured with a transparent electrically conductive film made, for example, of ITO. The liquid crystal alignment control electrodes 55 may each be configured with a transparent electrically conductive film made, for example, of ITO, as the pixel electrodes 56. Instead, the liquid crystal alignment control electrodes 55, which are each formed in a region that does not contribute to display, may each be configured, for example, with a metal film. The insulating film 38 is configured, for example, with a film made of silicon oxide (SiO₂), silicon nitride (SiN), aluminum oxide (Al₂O₃), or hafnium oxide (HfO₂). The film thickness of the insulating film 38 is desirably thin to the extent that the insulating film 38 can maintain the state in which the pixel electrodes 56 and the liquid crystal alignment control electrodes 55 are insulated from each other. The reason for this is that when the insulating film 38 has a small film thickness, a lateral electric field is likely to be generated between the pixel electrodes 56 and the liquid crystal alignment control electrodes 55, so that the second torque is likely to be generated.

In the present embodiment, when the element substrate is viewed in the direction of a normal thereto as a plan view, a portion of the liquid crystal alignment control electrodes 55 and a portion of the pixel electrodes 56 overlap with each other, as shown in FIG. 17. Note that the liquid crystal alignment control electrodes 55 and the pixel electrodes 56 may not necessarily overlap with each other as in the first embodiment. The positional relationship between two liquid crystal alignment control electrodes 55A and 55B electrically coupled to one pixel electrode 56 is the same as that in the first embodiment.

Other elements of the liquid crystal device are substantially the same as those of the liquid crystal device according to the first embodiment.

### Advantages of third embodiment

In the liquid crystal device according to the present embodiment, the liquid crystal alignment control electrodes 55 and the pixel electrodes 56 are located at levels different from each other, but two liquid crystal alignment control electrodes 55A and 55B are electrically coupled to one pixel electrode 56, as in the first embodiment. Therefore, also in the present embodiment, since the first torque, which causes the reverse tilt domain, is canceled by the second torque, which attempts to rotate the liquid crystal molecules Lb in the direction opposite the direction in which the first torque attempts to rotate the liquid crystal molecules Lb, the present embodiment can also provide the same advantage provided by the first embodiment, that is, the display failure due to the reverse tilt domain can be reduced.

Furthermore, in the present embodiment, since the liquid crystal alignment control electrodes 55 and the pixel electrodes 56 are located at levels different from each other, a portion of the liquid crystal alignment control electrodes 55 and a portion of the pixel electrodes 56 can be arranged to overlap with each other in the plan view, as shown in FIG. 17. It is therefore not necessary to provide the pixel electrodes with cutouts where the liquid crystal alignment control electrodes are disposed and to separate the pixel electrodes and the liquid crystal alignment control electrodes from each other, unlike in the first embodiment. The shape of the pixel electrodes 56 can thus be designed with increased flexibility. As a result, the disturbance of the alignment of the liquid crystal molecules due to the configuration in which the pixel electrodes are provided with the cutouts can be suppressed.

Contrary to the configuration described above, the liquid crystal alignment control electrodes 55 may be provided above the pixel electrodes 56, and the pixel electrodes 56 may be provided below the liquid crystal alignment control electrodes 55. It is, however, preferable that the insulating film 38 is not disposed above the pixel electrodes 56, so that the configuration described above is preferable.

### Fourth embodiment

A fourth embodiment of the present disclosure will be described below with reference to the drawings.

The basic configuration of a liquid crystal device according to the fourth embodiment is the same as that in the first embodiment, and will therefore not be described.

The present embodiment differs from the first embodiment in the configurations of the pixel electrodes and the liquid crystal alignment control electrodes.

FIG. 19 is a cross-sectional view of the element substrate in the liquid crystal device according to the present embodiment.

In the liquid crystal device according to the present embodiment, liquid crystal alignment control electrodes 57 are provided in recesses 36h provided in the insulating film 36 located below pixel electrodes 58, as shown in FIG. 19. The liquid crystal alignment control electrodes 57 are each configured with a metal film made, for example, of tungsten. The liquid crystal alignment control electrodes 57 can be formed by a technology for forming the recesses 36h in the insulating film 36, then embedding metal such as tungsten in the recesses 36h, and planarizing the surface of the metal, that is, what is called a tungsten plug technology or the like. The pixel electrodes 58 are each configured with a transparent electrically conductive film made, for example, of ITO, and are formed on the insulating film 36.

Other elements of the liquid crystal device are substantially the same as those of the liquid crystal device according to the first embodiment.

### Advantages of fourth embodiment

Also in the liquid crystal device according to the present embodiment, since the first torque, which causes the reverse tilt domain, is canceled by the second torque, which attempts to rotate the liquid crystal molecules in the direction opposite the direction in which the first torque attempts to rotate the liquid crystal molecules, the present embodiment can also provide the same advantage provided by the first embodiment, that is, the display failure due to the reverse tilt domain can be reduced.

The present embodiment further provides the advantages below.

In the first embodiment, since the liquid crystal alignment control electrodes 11 and the pixel electrodes 10 are configured with electrically conductive films provided at the same level, the distance between the liquid crystal alignment control electrodes 11 and the pixel electrodes 10 is determined by the resolution of an exposure apparatus used in the manufacturing process, so that there is a limit to the reduction in the distance. As a result, the space between adjacent pixels protrudes from a wiring region, which causes a decrease in contrast of a displayed image. In contrast, in the present embodiment, the distance between the liquid crystal alignment control electrodes 57 and the pixel electrodes 58 is determined by overlay accuracy between the transparent electrically conductive film that constitutes the pixel electrodes 58 and the tungsten plug that constitutes the liquid crystal alignment control electrodes 57. The distance between the liquid crystal alignment control electrodes 57 and the pixel electrodes 58 can therefore be made smaller than that in the first embodiment, so that the decrease in contrast due to the situation in which the space between adjacent pixels protrudes from the wiring region can be suppressed.

In the third embodiment, it is necessary to form the insulating film 38 interposed between the liquid crystal alignment control electrodes 55 and the pixel electrodes 56, which increases the manufacturing load. In addition, it is necessary to accurately manage the film thickness of the insulating film 38. In contrast, in the present embodiment, it is not necessary to form an insulating film interposed between the liquid crystal alignment control electrodes 57 and the pixel electrodes 58, so that the manufacturing load can be reduced as compared with that in the third embodiment.

### Fifth embodiment

A fifth embodiment of the present disclosure will be described below with reference to the drawings.

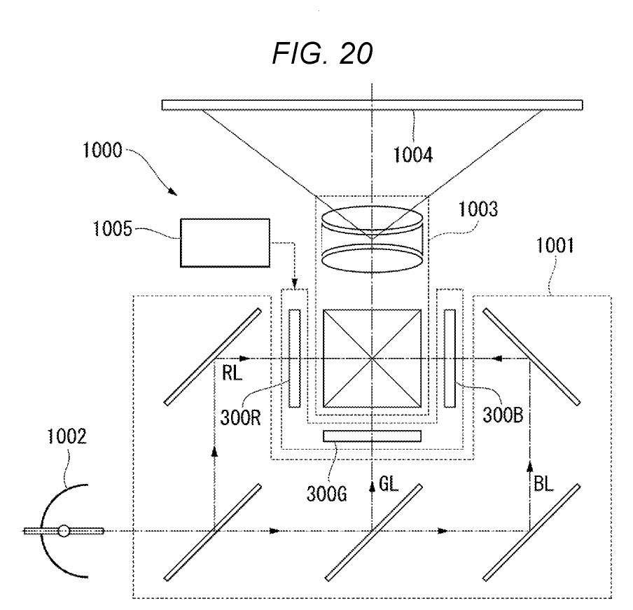

FIG. 20 is a diagrammatic view showing an example of an electronic apparatus, and is a diagrammatic view showing a schematic configuration of a projection-type display apparatus 1000 as the electronic apparatus.

The projection-type display apparatus 1000 is a three-plate projector including three sets of the liquid crystal device 300 described above, as shown in FIG. 20. A liquid crystal device 300R corresponds to a red display color, a liquid crystal device 300G corresponds to a green display color, and a liquid crystal device 300B corresponds to a blue display color. A controller 1005 includes, for example, a processor and a memory, and controls the operation of the liquid crystal devices 300R, 300G, and 300B.

An illumination system 1001 receives light output from an illuminator 1002, which is a light source, and causes red light RL out of the output light to enter the liquid crystal device 300R, causes green light GL out of the output light to enter the liquid crystal device 300G, and causes blue light BL out of the output light to enter the liquid crystal device 300B. The light source of the illuminator 1002 can, for example, be a halogen lamp, a mercury lamp, a light emitting diode, or a combination of a laser light source and fluorescence as appropriate. The liquid crystal devices 300R, 300G, and 300B function as light modulators that modulate the multiple types of color light RL, GL, and BL incident from the illumination system 1001 in accordance with an image to be displayed. A projection system 1003 combines light output from the liquid crystal device 300R, light output from the liquid crystal device 300G, and light output from the liquid crystal device 300B with one another, and projects the combined light onto a screen 1004.

The projection-type display apparatus 1000 as the electronic apparatus according to the present embodiment includes the liquid crystal devices 300 according to any of the embodiments described above.

According to the configuration described above, the projection-type display apparatus 1000 can be an apparatus that suppresses the display failure caused by the reverse tilt domain and has excellent display quality.

Note that the electronic apparatus is not limited to the three-panel projector presented by way of example. For example, the electronic apparatus may be a single-plate projector, a two-plate projector, or a projector including four or more liquid crystal devices 300. The electronic apparatus including the liquid crystal devices according to any of the embodiments described above may instead be an electrical view finder (EVF), a mobile mini-projector, a head-up display, a smartphone, a personal digital assistant (PDA), a digital camera, a digital camcorder, a television, a personal computer, a display, electronic paper, a calculator, a video phone, a point of sale (POS), a printer, a scanner, a copier, a video player, an instrument including a touch panel, an in-vehicle instrument such as a car navigation apparatus, an audio instrument, an exposure apparatus, an illumination instrument, or the like.

Note that the technical scope of the present disclosure is not limited to the embodiments described above, and various changes can be made thereto to the extent that the changes do not depart from the intent of the present disclosure.

For example, the specific description of the shapes, the numbers, the arrangements, the materials, and other factors of the elements of the liquid crystal device are not limited to those in the embodiments described above and can be changed as appropriate.

### Summary of present disclosure

The present disclosure will be summarized below as additional remarks.

### Additional Remark 1

A liquid crystal device including:

a first substrate;

a second substrate; and

a liquid crystal layer interposed between the first substrate and the second substrate, and including liquid crystal molecules having negative dielectric anisotropy,

wherein the first substrate includes

multiple scan lines,

multiple data lines extending in a direction that intersects with a direction in which the scan lines extend,

multiple pixel electrodes arranged in a matrix in correspondence with intersections of the scan lines and the data lines,

multiple liquid crystal alignment control electrodes configured to control azimuth angle directions of major axes of the liquid crystal molecules when a voltage is applied to the liquid crystal layer, and

an alignment film provided on a side of the first substrate that is a side in contact with the liquid crystal layer, and configured to impart a pretilt angle to the liquid crystal molecules, and

the liquid crystal alignment control electrodes are configured to generate an electric field that generates a second torque acting in a direction opposite a direction in which a first torque acts, the first torque generated when voltages different from each other are applied to two of the pixel electrodes that are adjacent to each other, the first torque rotating the liquid crystal molecules to be oriented in an azimuth angle direction.

According to the configuration described in Additional Remark 1, since the first torque, which causes the reverse tilt domain, is canceled by the second torque oriented to rotate the liquid crystal molecules in the direction opposite the direction in which the first torque rotates the liquid crystal molecules, the display failure due to the reverse tilt domain can be reduced.

### Additional Remark 2

The liquid crystal device according to Additional Remark 1, wherein

the multiple liquid crystal alignment control electrodes are each provided between the two pixel electrodes adjacent to each other,

two of the multiple liquid crystal alignment control electrodes are electrically coupled to one of the multiple pixel electrodes, and

the two liquid crystal alignment control electrodes have potential equal to potential of the one pixel electrode in a state in which a voltage is applied to the one pixel electrode to generate an electric field that generates the second torque.

According to the configuration described in Additional Remark 2, the two liquid crystal alignment control electrodes have potential equal to the potential of one pixel electrode without providing a switching element in each of the liquid crystal alignment control electrodes to generate an electric field, so that a reverse tilt domain generated on a pixel electrode adjacent to the one pixel electrode decreases. The display failure due to the reverse tilt domain can thus be reduced.

### Additional Remark 3

The liquid crystal device according to Additional Remark 2, wherein

the one pixel electrode is a pixel electrode located in an m-th row and an n-th column (m and n are integers greater than or equal to one) out of the multiple pixel electrodes,

the two liquid crystal alignment control electrodes electrically coupled to the one pixel electrode are a first liquid crystal alignment control electrode located between a pixel electrode located in an (m−1)-th row and an (n−1)-th column and a pixel electrode located in the (m−1)-th row and the n-th column, and a second liquid crystal alignment control electrode located between a pixel electrode located in the m-th row and an (n+1)-th column and a pixel electrode located in an (m+1)-th row and the (n+1)-th column, and

an azimuth angle direction of the pre-tilted liquid crystal molecules is a direction in which a pixel electrode located in the (m+1)-th row and the (n−1)-th column, the pixel electrode located in the m-th row and the n-th column, and a pixel electrode located in the (m−1)-th row and the (n+1)-th column are arranged.

According to the configuration described in Additional Remark 3, for example, when a black line extending in the vertical direction or the horizontal direction of a screen is displayed, display failure in which black is erroneously displayed and which occurs in pixels adjacent to the black line and displayed in white can be unlikely to be visually recognized.

### Additional Remark 4

The liquid crystal device according to Additional Remark 3, wherein

the first liquid crystal alignment control electrode has a strip shape extending along sides of two of the pixel electrodes that are adjacent to each other in the (m−1)-th row, the sides facing each other, and

the second liquid crystal alignment control electrode has a strip shape extending along sides of two of the pixel electrodes that are adjacent to each other in the (n+1)-th column, the sides facing each other.

According to the configuration described in Additional Remark 4, since the first and second liquid crystal alignment control electrodes each have a strip shape extending along sides of adjacent pixel electrodes that are sides facing each other, display failure in which black is erroneously displayed and which occurs in pixels adjacent to the black line and displayed in white can be more favorably suppressed.

### Additional Remark 5

The liquid crystal device according to Additional Remark 2, wherein

the one pixel electrode is a pixel electrode located in an m-th row and an n-th column (m and n are integers greater than or equal to one) out of the multiple pixel electrodes,

the two liquid crystal alignment control electrodes electrically coupled to the one pixel electrode are a first liquid crystal alignment control electrode located between a pixel electrode located in an (m−1)-th row and the n-th column and a pixel electrode located in the (m−1)-th row and an (n+1)-th column, and a second liquid crystal alignment control electrode located between a pixel electrode located in the (m−1)-th row and the (n+1)-th column and a pixel electrode located in the m-th row and the (n+1)-th column, and

an azimuth angle direction of the pre-tilted liquid crystal molecules is a direction in which a pixel electrode located in an (m+1)-th row and an (n−1)-th column, the pixel electrode located in the m-th row and the n-th column, and the pixel electrode located in the (m−1)-th row and the (n+1)-th column are arranged.

According to the configuration described in Additional Remark 5, for example, when a black line extending in the vertical direction or the horizontal direction of the screen is displayed, display failure in which black is erroneously displayed and which occurs in pixels adjacent to the black line and displayed in white can be unlikely to be visually recognized.

### Additional Remark 6

The liquid crystal device according to Additional Remark 5, wherein

the first liquid crystal alignment control electrode has a strip shape extending along sides of two of the pixel electrodes that are adjacent to each other in the (m−1)-th row, the sides facing each other, and

the second liquid crystal alignment control electrode has a strip shape extending along sides of two of the pixel electrodes adjacent to each other in the (n+1)-th column, the sides facing each other.

According to the configuration described in Additional Remark 6, since the first and second liquid crystal alignment control electrodes each have a strip shape extending along sides of adjacent pixel electrodes that are sides facing each other, display failure in which black is erroneously displayed and which occurs in pixels adjacent to the black line and displayed in white can be more favorably suppressed.

### Additional Remark 7

The liquid crystal device according to any one of Additional Remarks 1 to 6, wherein

the liquid crystal alignment control electrodes and the pixel electrodes are configured with electrically conductive films provided at the same level.

The configuration described in Additional Remark 7, in which the liquid crystal alignment control electrodes and the pixel electrodes can be simultaneously formed in one step, can simplify the manufacturing process.

### Additional Remark 8

The liquid crystal device according to any one of Additional Remarks 1 to 6, wherein

the liquid crystal alignment control electrodes and the pixel electrode are configured with electrically conductive films provided at levels different from each other,

the liquid crystal alignment control electrodes are provided on a lower side,

the pixel electrodes are provided on an upper side, and

an insulating film is interposed between the liquid crystal alignment control electrodes and the pixel electrodes.

According to the configuration described in Additional Remark 8, for example, a portion of the liquid crystal alignment control electrodes and a portion of the pixel electrodes can be disposed to overlap with each other in the plan view. The shape of the pixel electrodes can thus be designed with increased flexibility. As a result, the disturbance of the alignment of the liquid crystal molecules resulting from the shape of the pixel electrodes can be suppressed.

### Additional Remark 9

The liquid crystal device according to any one of Additional Remarks 1 to 6, wherein

the liquid crystal alignment control electrodes and the pixel electrode are configured with electrically conductive films provided at levels different from each other,

the liquid crystal alignment control electrodes are provided in recesses in an insulating film located below the pixel electrodes, and

the pixel electrodes are provided on the insulating film.

According to the configuration described in Additional Remark 9, the distance between the liquid crystal alignment control electrodes and the pixel electrodes is readily reduced, so that a decrease in contrast due to a situation in which the space between adjacent pixels protrudes from a wiring region can be suppressed. Furthermore, it is not necessary to form the insulating film interposed between the liquid crystal alignment control electrodes and the pixel electrodes, which can reduce the manufacturing load.

### Additional Remark 10

An electronic instrument including the liquid crystal device according to any one of Additional Remarks 1 to 9.

According to the configuration described in Additional Remark 10, the electronic instrument can be an instrument that suppresses the display failure caused by the reverse tilt domain and has excellent display quality.

What is claimed is:

1. A liquid crystal device comprising: a first substrate; a second substrate; and a liquid crystal layer interposed between the first substrate and the second substrate, and including liquid crystal molecules having negative dielectric anisotropy, wherein the first substrate includes multiple scan lines, multiple data lines extending in a direction that intersects with a direction in which the scan lines extend, multiple pixel electrodes arranged in a matrix in correspondence with intersections of the scan lines and the data lines, multiple liquid crystal alignment control electrodes configured to control azimuth angle directions of major axes of the liquid crystal molecules when a voltage is applied to the liquid crystal layer, and an alignment film provided on a side of the first substrate that is a side in contact with the liquid crystal layer, and configured to impart a pretilt angle to the liquid crystal molecules, and the liquid crystal alignment control electrodes are configured to generate an electric field acting in a direction opposite a direction in which the liquid crystal molecules are rotated to be oriented in an azimuth angle direction when voltages different from each other are applied to two of the pixel electrodes that are adjacent to each other.

2. The liquid crystal device according to claim 1, wherein the multiple liquid crystal alignment control electrodes are each provided between the two pixel electrodes adjacent to each other, two of the multiple liquid crystal alignment control electrodes are electrically coupled to one of the multiple pixel electrodes, and the two liquid crystal alignment control electrodes have potential equal to potential of the one pixel electrode in a state in which a voltage is applied to the one pixel electrode to generate an electric field that changes the azimuth angle of the liquid crystal molecules to an azimuth angle in an opposite direction.

3. The liquid crystal device according to claim 2, wherein
the one pixel electrode is a pixel electrode located in an m-th row and an n-th column out of the multiple pixel electrodes, and m and n are integers greater than or equal to one,
the two liquid crystal alignment control electrodes electrically coupled to the one pixel electrode are a first liquid crystal alignment control electrode located between a pixel electrode located in an (m−1)-th row and an (n−1)-th column and a pixel electrode located in the (m−1)-th row and the n-th column, and a second liquid crystal alignment control electrode located between a pixel electrode located in the m-th row and an (n+1)-th column and a pixel electrode located in an (m+1)-th row and the (n+1)-th column, and
an azimuth angle direction of the pre-tilted liquid crystal molecules is a direction in which a pixel electrode located in the (m+1)-th row and the (n−1)-th column, the pixel electrode located in the m-th row and the n-th column, and a pixel electrode located in the (m−1)-th row and the (n+1)-th column are arranged.

4. The liquid crystal device according to claim 3, wherein
the first liquid crystal alignment control electrode has a strip shape extending along sides of two of the pixel electrodes that are adjacent to each other in the (m−1)-th row, the sides facing each other, and
the second liquid crystal alignment control electrode has a strip shape extending along sides of two of the pixel electrodes that are adjacent to each other in the (n+1)-th column, the sides facing each other.

5. The liquid crystal device according to claim 2, wherein
the one pixel electrode is a pixel electrode located in an m-th row and an n-th column out of the multiple pixel electrodes, and m and n are integers greater than or equal to one,
the two liquid crystal alignment control electrodes electrically coupled to the one pixel electrode are a first liquid crystal alignment control electrode located between a pixel electrode located in an (m−1)-th row and the n-th column and a pixel electrode located in the (m−1)-th row and an (n+1)-th column, and a second liquid crystal alignment control electrode located between a pixel electrode located in the (m−1)-th row and the (n+1)-th column and a pixel electrode located in the m-th row and the (n+1)-th column, and
an azimuth angle direction of the pre-tilted liquid crystal molecules is a direction in which a pixel electrode located in an (m+1)-th row and an (n−1)-th column, the pixel electrode located in the m-th row and the n-th column, and the pixel electrode located in the (m−1)-th row and the (n+1)-th column are arranged.

6. The liquid crystal device according to claim 5, wherein
the first liquid crystal alignment control electrode has a strip shape extending along sides of two of the pixel electrodes that are adjacent to each other in the (m−1)-th row, the sides facing each other, and
the second liquid crystal alignment control electrode has a strip shape extending along sides of two of the pixel electrodes that are adjacent to each other in the (n+1)-th column, the sides facing each other.

7. The liquid crystal device according to claim 1, wherein
the liquid crystal alignment control electrodes and the pixel electrodes are configured with electrically conductive films provided at the same level.

8. The liquid crystal device according to claim 1, wherein
the liquid crystal alignment control electrodes and the pixel electrode are configured with electrically conductive films provided at levels different from each other,
the liquid crystal alignment control electrodes are provided on a lower side, the pixel electrodes are provided on an upper side, and an insulating film is interposed between the liquid crystal alignment control electrodes and the pixel electrodes.

9. The liquid crystal device according to claim 1, wherein
the liquid crystal alignment control electrodes and the pixel electrode are configured with electrically conductive films provided at levels different from each other,
the liquid crystal alignment control electrodes are provided in recesses in an insulating film located below the pixel electrodes, and the pixel electrodes are provided on the insulating film.

10. An electronic instrument comprising the liquid crystal device according to claim 1.
